(19) United States
(12) Patent Application Publication
(10) Pub. No.: US 2007/0211639 A1
(43) Pub. Date: Sep. 13, 2007

(54) Central Interception and Evaluation Unit

(75) Inventor: Bernhard Spalt, Wien (AT)

Correspondence Address: MORRISON & FOERSTER LLP, 1650 TYSONS BOULEVARD, SUITE 400, MCLEAN, VA, 22102, US

(73) Assignee: Siemens Aktiengesellschaft, Munchen (DE)

(21) Appl. No.: 10/557,483

(22) PCT Filed: Apr. 27, 2004
(86) PCT No.: PCT/EP04/50614

§ 371 Date: Jan. 25, 2007

(30) Foreign Application Priority Data
May 21, 2003 (DE) 10323006.8

(51) Int. Cl. H04L 12/26

(52) U.S. Cl. 370/241

(57) ABSTRACT

Disclosed are a particularly efficient and resource-saving method and device for intercepting at least one user of a communication terminal in a communication network. The invention is characterized in that a central interception and evaluation unit (BAA) receives service data of at least one communication terminal (MS), said received service data is evaluated according to at least one predefined filtering criterion, and at least one evaluation result is forwarded to another network unit (LEA).

### CLAIM FOR PRIORITY

This application is a national stage of PCT/EP2004/050614 which was published on Dec. 2, 2004 and which claims the benefit of priority to German Application No. 103 23 006.8 filed May 21, 2003.

### TECHNICAL FIELD OF THE INVENTION

The invention relates to a method and a device for intercepting at least one user of a communication terminal in a communication network.

### BACKGROUND OF THE INVENTION

Service-dependent monitoring of users of a communication terminal among network operators or telecommunication service providers (TSP) and internet service providers (ISP) is being required increasingly by authorities.

Communication terminals can be mobile radio terminals, fixed network terminals, stationary and mobile computers or similar. Services can be, for example, radio broadcasting, television, multimedia services, multimedia broadcast services, multicast services, etc. Previous solutions, such as, for example, sniffer solutions, for intercepting and searching such services are aimed at analyzing the content of the communication for keywords or, as the case may be, details (information on services). Sniffer solutions are typically used by intelligence services and require large system resources.

It is known from the publications TS 33.107 and TS 33.108 on interception (monitoring) and TS 22.071 on LCS (Location Services) (see www.etsi.org) that during the interception of data (voice data/short message data/other data) of a mobile radio subscriber to be monitored in a mobile radio communications network by a (generally national) interception center from a switching center (e.g. MSC or SGSN via which data of the subscriber to be monitored is transmitted), in addition to said data, further descriptive data relating to this communication, such as, for example, location information relating to the current or last recorded location of the subscriber is also transmitted to the data center in an “IRI data record”. The location data transferred in the intercept information packet IRI (=interception related information) represents the location information of the mobile radio subscriber in the form of a cell information identity (available to the switching center or requested by the switching center from a home location register (HLR/HSS) of the mobile radio communications network) which indicates in which cell or cell group the mobile radio subscriber was last registered.

### SUMMARY OF THE INVENTION

The present invention proposes an efficient method for intercepting services that is economical in its use of resources.

In one embodiment of the invention, a central interception and evaluation unit in a communication network receives service data of at least one communication terminal and evaluates said service data. The result of the evaluation of the service data can be used (if necessary) to start a time-limited (only for this communication) monitoring operation in other network units.

One advantage of this invention is that no modifications to the usual signaling between the network units (separate signaling for the interception) are necessary and that only a slight load is placed on the system resources (already available administration interfaces are used for the interception).

### BRIEF DESCRIPTION OF THE DRAWINGS

The invention will be explained in more detail with reference to the exemplary embodiments illustrated in the figures, in which:

FIG. 1 shows the interworking of the central interception and evaluation unit with other network units.

FIG. 2 shows the central interception and evaluation unit.

### DETAILED DESCRIPTION OF THE INVENTION

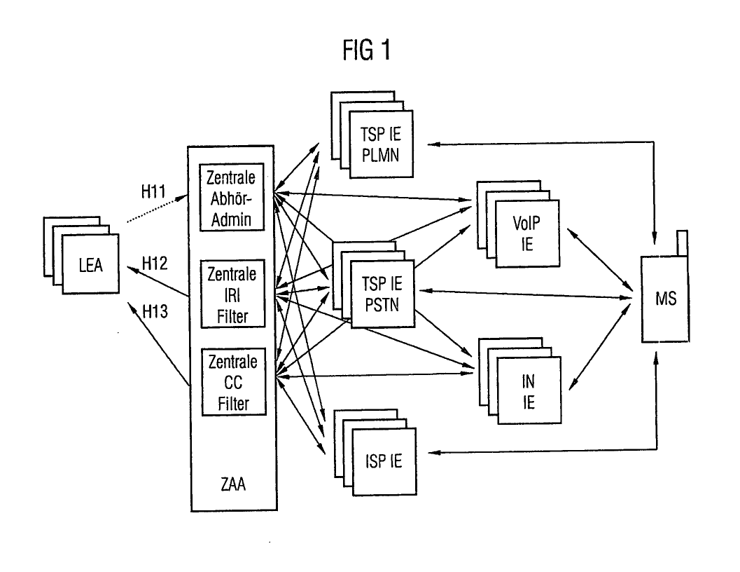

FIG. 1 shows a simplified diagram depicting the interworking of the central interception and evaluation unit ZAA with other network units. Such network units can be different interception and information units in communication networks, such as, for example, TSP IE PLMN in a mobile communication network, TSP IE PSTN in a fixed network, VoIP IE or ISP IE on the internet, or IN IE in an intelligent data network. Users of a communication terminal MS participating in a service are intercepted. A service can be a voice service, a multicast, multimedia or message service and/or similar. Intercept orders are activated/deactivated centrally and are submitted by a law enforcement agency LEA via an HI1 interface. It is also possible that a central interception and evaluation unit ZAA intercepts further network units without an intercept order (preventive intelligence service and/or general data gathering relating to retroactive surveillance operations) and stores the evaluation results and/or delivers them to a law enforcement agency LEA. At the same time data (IMEI) which indicates the multimedia capability, characteristics or other services of a network unit MS to be intercepted can also be registered by an interception and evaluation unit ZAA, stored and if necessary transferred to a law enforcement agency LEA.

A central interception and evaluation unit ZAA determines the relevant network units TSP IE PLMN, TS PIE PSTN, ISP IE, VoIP IE, IN IE and activates/deactivates the intercept. The intercept includes data on the content of the communication and IRI information with location information LI (if monitoring is taking place in a mobile radio terminal with collection of location information). In the process evaluations are produced from the obtained data by the central interception and evaluation unit ZAA taking into account conditions and statutory regulations. The relevant network units TSP IE PLMN, TSP IE PSTN, ISP IE, VoIP IE, IN IE can also be specified in accordance with a possible judicial authorization.

Filter criteria are defined in an IRI filter and/or CC (Content of Communication) filter in accordance with conditions and rules of the law enforcement agency LEA and the data obtained evaluated according to the filter criteria. Filter criteria of this kind can include, for example: no location information, without short message (SMS) content, voice services only, electronic messages (emails) only, no prohibited services, no communication with specific call numbers, such as e.g. telephone numbers of politicians, etc. A central interception and evaluation unit ZAA can intercept data relating to specific services, such as e.g. short messages (SMS), voice, data, fax, voice over IP (VoIP), internet, etc. Filters, conditions and rules can be set up, such as, for example, only parts of short messages, no location information, no partner information etc. It may also be necessary to use filters, conditions and rules to restrict the receiving or, as the case may be, retrieval of data and/or evaluation results by network units such as a law enforcement agency LEA. The intercept is then performed in accordance with the filters, conditions and rules. The result of the evaluation is subsequently transferred via the interfaces HI 2 and HI 3 to a law enforcement agency LEA. The central interception and evaluation unit ZAA can combine intercept data relating to different services, such as, for example, with whom the partner of the person under surveillance is communicating. A law enforcement agency LEA can also be allowed active access to all and/or specific data, such as, for example, data relating to a service. The central interception and evaluation unit ZAA can store the intercept data obtained (in this exemplary embodiment, either all or, for example, only charging information can be sent to the interception and evaluation unit ZAA) so that it will be possible to carry out a retroactive monitoring operation/data analysis. The interception and evaluation unit ZAA can also buffer the obtained data when there are transmission problems via the interfaces to a law enforcement agency LEA. Intercept data relating to a user of a communication terminal MS can also be stored in the central interception and evaluation unit ZAA on a longer-term basis for identification purposes so that further information gathering operations can be implemented without further overhead for the telecommunication service providers. By means of a centralized storage of all offered intercept data it would be possible to dispense with the delivery of data to all monitoring intercept equipment TSP IE PLMN, TSP IE PSTN, ISP IE, VOIP IE, IN IE and only relevant data could be read out. Central storage in an interception and evaluation unit ZAA can be performed by the telecommunication service provider, the service provider or by a central authority. The storage period can be defined in statutory legislation. As an option, the intercept units TSP IE PLMN, TSP IE PSTN, ISP IE, VoIP IE, IN IE can be allowed to access the central storage element in a central interception and evaluation unit ZAA. If necessary the interception conditions and regulations can be amended at short notice and possibly for a limited time. In the case of multimedia broadcast and multicast services (MBMS) the available services can also be restricted through the combined evaluation of stored data of the broadcast/multicast services with subscription and location information. For this purpose an additional data transmission by the broadcast/multicast service provider is necessary, detailing when, where and which services are offered. The date and/or time can or, as the case may be, should be included in the transferred data.

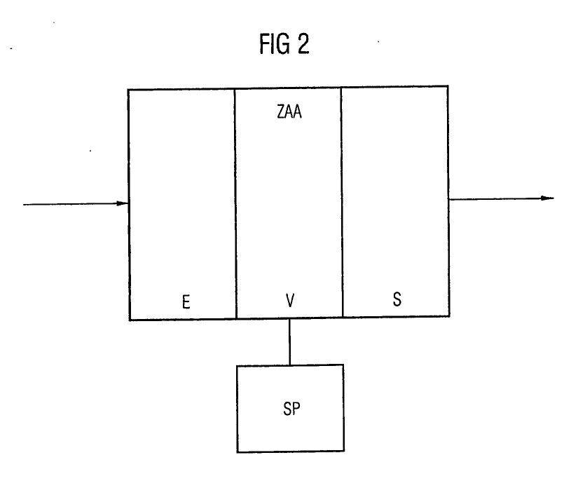

FIG. 2 shows a simplified diagram depicting a central interception and evaluation unit ZAA. Intercept data of further network units TSP IE PLMN, TSP IE PSTN, ISP IE, VoIP IE, IN IE is forwarded via a receiving unit E to a processing unit V. The processing unit V specifies filters in accordance with conditions and rules and produces an evaluation result. Said evaluation result is sent via a transmitting unit S to a law enforcement agency LEA. The obtained intercept data and/or the evaluation result can be stored in a storage element SP to enable retrieval actions or, as the case may be, evaluations to be carried out at a later time. The evaluation result can be sent in an IRI intercept information packet with an extension for the content of the communication to a law enforcement agency LEA. The service data and/or the evaluation result can also be transferred in encrypted form to a law enforcement agency LEA. The encoding can then be performed using a suitable key server. The reception and/or retrieval options of a law enforcement agency LEA can be restricted by means of filters in the central interception and evaluation unit. Said filters are set and activated in accordance with conditions and statutory provisions.

Abbreviations:

AAA Authentication, Authorization and Accounting
ADMF Administration Function
CC Content of Communication
DF Delivery Function
E Receiving unit
ES European Standard
GMSC Gateway MSC
HI Handover Interface
HLR Home Location Register
HSS Home Subscriber Service
IE Interception Equipment
IIF Internal Interception Function
IN Intelligent Network
IMS IP Multimedia Subsystem
IRI Interception Related Information
ISP Internet Service Provider
LEA Law Enforcement Agency
MF Mediation Function
MSC Mobile Switching Center
S Transmitting unit
SIP Session Initiation Protocol
PLMN Public Land Mobile Network
PSTN Public Switched Telephone Network
TSP Telecommunication Service Provider
V Processing unit
VLR Visitor Location Register
VOIP Voice over IP
ZAA Central interception and evaluation unit

1. A method for intercepting at least one user of a communication terminal in a communication network, comprising:
obtaining, from a central interception and evaluation unit, service data of at least one communication terminals;
evaluating the obtained service data in accordance with at least one predefined filter criterion; and
at least one evaluation result is forwarded to a further network unit.

2. The method as claimed in claim 1, wherein
at least one of the obtained service data and at least one evaluation result is stored in a storage element of a central interception and evaluation unit.

3. The method as claimed in claim 1, wherein
at least one filter criterion is defined in an IRI and/or Content of Communication filter of a central interception and evaluation unit.

4. The method as claimed in claim 1, wherein
a central interception and evaluation unit obtains service data of a communication terminal from at least one network unit in a telephone network and/or data network.

5. The method as claimed in claim 1, wherein
service data is the data relating to a service that is sent to a communication terminal and/or to be received by a communication terminal.

6. The method as claimed in claim 1 wherein
the central interception and evaluation unit obtains characteristic data of a communication terminal and evaluates and/or stores the data in a storage element.

7. The method as claimed in claim 1, wherein
at least one evaluation result is forwarded to a further network unit.

8. The method as claimed in claim 1, wherein
a further network unit represents a law enforcement agency of an executive organ of a state.

9. The method as claimed in claim 1, wherein
a further network unit interrogates a central interception and evaluation unit in to retrieve at least one of service data and at least one evaluation result stored in a storage element.

10. The method as claimed in claim 1, wherein
the communication network is a telephone and/or data network.

11. The method as claimed in claim 1, wherein
a further network unit obtains and/or retrieves service data and/or at least one evaluation result in filtered form.

12. The method as claimed in claim 1, wherein
the evaluation result is forwarded in an intercept information packet by a central interception and evaluation unit to a law enforcement agency.

13. The method as claimed in claim 1, wherein
multicast and/or multimedia service data is received, evaluated and/or stored by a central interception and evaluation unit and/or sent to a law enforcement agency.

14. The method as claimed in claim 1, wherein
the interception and evaluation unit is a network unit in a communication network.

15. The method as claimed in claim 1, wherein
service data and/or at least one evaluation result is transmitted in encrypted form to a further network unit.

16. The method as claimed in claim 1, wherein
a central interception and evaluation unit in a communication network receives service data of at least two communication terminals and combines the data in an evaluation result.

17. An interception and evaluation unit for intercepting at least one user of a communication terminal in a communication network, comprising:
a receiving unit for receiving service data relating to different services of at least one communication terminal;
a processing unit for evaluating the service data relating to different services in accordance with at least one defined filter criterion; and
a transmitting unit for sending the evaluation result to further network units.

18. The interception and evaluation unit as claimed in claim 10, wherein
a storage element is provided for storing service data and/or at least one evaluation result.
